(19) United States
(12) Patent Application Publication
(10) Pub. No.: US 2011/0200864 A1
(43) Pub. Date: Aug. 18, 2011

(54) STABLE ELECTROLYTES FOR HIGH VOLTAGE BATTERIES AND THE BATTERIES DERIVED THEREFROM

(75) Inventor: Jinxiang Dai, Mansfield Storrs, CT (US)

(73) Assignee: U.S. NANOCORP, INC., Manchester, CT (US)

(21) Appl. No.: 13/028,825

(22) Filed: Feb. 16, 2011

Related U.S. Application Data
(60) Provisional application No. 61/305,362, filed on Feb. 17, 2010.

(51) Int. Cl. H01M 10/02

(52) U.S. Cl. 429/152; 429/188; 429/199

(57) ABSTRACT

An electrolyte composition comprises lithium salts. The electrolyte composition is operative at temperatures of about 350 to about 600° C. in a battery. The electrolyte composition displays a specific conductivity of less than 10⁻⁷ Siemens per centimeter when the temperature is lower than 100° C. and greater than 10⁻³ Siemens per centimeter when the temperature is greater than 400° C. The electrolyte composition is devoid of a separator.

### CROSS-REFERENCE TO RELATED APPLICATIONS

This reference claims priority to U.S. Non-provisional application no. 61/305,362 filed on Feb. 17, 2010, the entire contents of which are incorporated herein.

### BACKGROUND

This disclosure relates to stable electrolytes for high voltage batteries and the batteries derived therefrom.

Primary thermal batteries are one-time activation reserve batteries that are widely used in missiles as power sources for controller systems. Compared with other reserve batteries, such as those comprising silver oxide/zinc or lithium/thionyl chloride, thermal batteries have advantages in reliability, a wide temperature range of operation of about −55° C. to about +70° C., a high power density, a long reserve life of greater than about 25 years and are, in general, maintenance free.

In commercially available primary thermal batteries, a eutectic mixture of salts, such as potassium chloride and lithium chloride (KCl-LiCl) is used as the electrolyte for a thermal battery. The battery generally uses a separator. These separators are porous and draw in electrolytes as a result of capillary action, which allows ions to travel through while maintaining mechanical integrity. The more porous the separator the more energy (in the form of ions) that can travel through. In thermal batteries, magnesium oxide (MgO) is often used as a separator.

The powder of a high surface area magnesium oxide is mixed with a powder of the eutectic KCl-LiCl electrolyte to form a mixture. The mixture is then cold pressed into a pellet to function as a separator/electrolyte layer in the thermal battery. At the working temperature of the thermal battery, the eutectic KCl-LiCl electrolyte will be melted and absorbed on the surface of magnesium oxide particles.

In addition, the eutectic KCl-LiCl electrolyte suffers from another drawback. In the eutectic LiCl-KCl electrolyte, the potassium ion (K⁺) conduction does not contribute to the reaction. The cell activity is mainly due to conductivity of the lithium ion (Li⁺). Therefore, the actual useful conductivity is less than the measured conductivity. Another problem with K⁺ and Li⁺ mixed cation electrolytes is the solidification of the electrolyte upon participating in a discharge reaction.

During the discharge, lithium ions are produced as a result of which the composition of the electrolyte will change, which often causes local solidification, which brings on increasing polarization in the electrolyte. This increasing polarization is detrimental to the functioning of the cell.

Magnesium oxide keeps the liquid eutectic KCl—LiCl from flowing. The performance of the MgO—KCl—LiCl depends on the physical properties of the magnesium oxide. The source of magnesium oxide is important for thermal battery manufacturers since its characteristics vary significantly with different sources. Low performance magnesium oxide or a lower amount of magnesium oxide in the mixture generally results in thermal battery failure at high levels of acceleration. This is because at high levels of acceleration, the liquid KCl—LiCl electrolyte is moved out of the cells causing short circuits among the serially connected cells in the batteries.

A high content of magnesium oxide will increase the mechanical strength, but it would also reduce the ionic conductivity. The manufacturers therefore have to compromise on the high electric performance and the mechanical robustness. It is therefore desirable to have a battery where the separator can be eliminated and where the electrolyte is thermally stable enough to withstand the high temperatures of operation without the presence of the separator.

### SUMMARY

Disclosed herein is an electrolyte composition comprising lithium salts; where the electrolyte composition is operative at temperatures of about 350 to about 600° C. in a battery and wherein the electrolyte composition displays a specific conductivity of less than 10⁻⁷ Siemens per centimeter when the temperature is lower than 100° C. and greater than 10⁻³ Siemens per centimeter when the temperature is greater than 400° C.; the electrolyte composition being devoid of a separator.

Disclosed herein too is a method comprising mixing together salts of lithium polyphosphate, lithium sulfate, lithium carbonate and lithium fluoride to form a mixture; heating the mixture to a temperature of about 400 to about 600 degrees centigrade for a period of about 1 to about 5 hours; and pressing the mixture together to form the electrolyte composition.

Disclosed herein is a method comprising spraying a solution comprising ions of lithium, phosphate, carbonate, sulfate and fluoride on a substrate; drying the solution to form a film or sheet; and heating the film or sheet to a temperature of about 400 to about 600° C. for about 1 to about 5 hours to produce an electrolyte composition.

### BRIEF DESCRIPTION OF THE FIGURES

FIG. 1 is a graph of the voltage versus the specific capacity of the cell containing the electrolyte composition versus a cell containing a LiCl—KCl—MgO electrolyte/separator. The cathode comprises 75 wt % Cu₃V₂O₈ and 25 wt % of the electrolyte composition;

FIG. 2 is a graph of the voltage versus the specific capacity of the cell containing the electrolyte composition versus a cell containing a LiCl—KCl—MgO electrolyte/separator. The cathode is a plasma sprayed LiV₃O₈ cathode; and

FIG. 3 is a discharge graph of a thermal battery made with the electrolyte compositions, LiSi alloy anodes, and a Cu₃V₂O₈ cathode. The battery containing 11 single cells was activated by igniting a built-in electric squib and a heating system. The heating system was consisting of Fe—KClO₄ heating pellets and Zr—BaCrO₄ heat papers.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout. Furthermore, all ranges disclosed herein are inclusive of the endpoints and independently combinable. As used herein, the term “and/or” includes any and all combinations of one or more of the associated listed items.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The transition phrase “comprising” is inclusive of the transition phrases “consisting essentially of” and “consisting of”.

The numerical ranges disclosed herein are inclusive of endpoints. All numbers within the respective numerical ranges are interchangeable.

Disclosed herein is an electrolyte composition that can advantageously be used in batteries without a separator. The electrolyte composition comprises a ternary or quarternary mixture of salts of lithium and is chemically inert to high voltage oxides cathode materials and metal anode materials. The electrolyte composition is an ionic conductor. The electrolyte has a melting point that is greater than 500° C. and can stay in the solid state at the battery's working temperature. Each individual salt of the electrolyte composition has a low ionic conductivity. However, the mixture produces a high ionic conductivity at the operating temperature of the battery.

The electrolyte composition comprises lithium polyphosphate (LiPO₃)ₙ, lithium sulfate (Li₂SO₄), lithium carbonate (Li₂CO₃) and lithium fluoride (LiF). Each of the salts present in the electrolyte composition is in the form of a powder prior to being formed into a pellet.

It is desirable for n to be equal to about 1 in the formula for the lithium polyphosphate (LiPO₃)ₙ. In an exemplary embodiment, the lithium polyphosphate is lithium metaphosphate. The lithium polyphosphate particles have a particle size of about 50 nanometers to about 500 micrometers, specifically about 75 nanometers to about 200 micrometers, specifically about 100 nanometers to about 100 micrometers, and more specifically about 1 micrometer to about 50 micrometers.

The lithium polyphosphate is present in an amount of about 10 to about 100 weight percent (wt %), specifically about 20 to about 90 wt %, and more specifically about 30 to about 50 wt %, based on the total weight of the electrolyte composition. An exemplary amount for the lithium polyphosphate in the electrolyte composition is about 40 to about 45 wt %.

The lithium sulfate particles have a particle size of about 50 nanometers to about 500 micrometers, specifically about 75 nanometers to about 200 micrometers, specifically about 100 nanometers to about 20 micrometers, and more specifically about 1 micrometer to about 10 micrometers. The lithium sulfate is present in an amount of about 5 to about 50 weight percent (wt %), specifically about 10 to about 40 wt %, and more specifically about 20 to about 35 wt %, based on the total weight of the electrolyte composition. An exemplary amount for the lithium sulfate in the electrolyte composition is about 25 to about 30 wt %.

The lithium carbonate particles have a particle size of about 50 nanometers to about 500 micrometers, specifically about 75 nanometers to about 200 micrometers, specifically about 100 nanometers to about 20 micrometers, and more specifically about 1 micrometer to about 10 micrometers. The lithium carbonate is present in an amount of about 5 to about 50 weight percent (wt %), specifically about 10 to about 40 wt %, and more specifically about 15 to about 35 wt %, based on the total weight of the electrolyte composition. An exemplary amount for the lithium carbonate in the electrolyte composition is about 17 to about 20 wt %.

The lithium fluoride particles have a particle size of about 50 nanometers to about 500 micrometers, specifically about 75 nanometers to about 200 micrometers, specifically about 100 nanometers to about 20 micrometers, and more specifically about 1 micrometer to about 10 micrometers. The lithium fluoride is present in an amount of about 5 to about 50 weight percent (wt %), specifically about 7 to about 40 wt %, and more specifically about 10 to about 35 wt %, based on the total weight of the electrolyte composition. An exemplary amount for the lithium fluoride in the electrolyte composition is about 11 to about 15 wt %.

In one embodiment, in one method of manufacturing the electrolyte composition, the lithium polyphosphate (LiPO₃)ₙ, lithium sulfate (Li₂SO₄), lithium carbonate (Li₂CO₃) and the lithium fluoride (LiF) can be ground to form a powdered mixture. The powdered mixture is heated to a temperature of about 400 to about 600° C. for about 1 to about 5 hours to remove moisture and to improve the uniformity of the powders in the composition.

At this temperature the powdered mixture is partially sintered but does not begin to flow. During the heating of the powdered mixture, a vacuum may be used to facilitate the rapid evaporation of moisture and other evaporative species. The sintered solid may be further ground or milled to form the electrolyte composition. The electrolyte composition is then cold pressed to form a pellet.

Alternatively, the electrolyte composition may be calendared or rolled in a two or three roll mill to form a sheet or a briquette. The electrolyte composition may also be tape cast to form a sheet.

In one embodiment, the electrolyte composition can be compression molded or injection molded to a size and shape effective to be used in a battery. The electrolyte composition may be formed into a membrane, a film, a sheet or a pellet.

In another embodiment, the electrolyte composition can be manufactured from a variety of different precursors. The precursors can be the precursors of lithium polyphosphate, lithium sulfate, lithium carbonate and lithium fluoride, such as lithium dihydrogen phosphate (LiH₂PO₄), ammonium dihydrogen phosphate (NH₄)H₂PO₄, ammonium sulfate (NH₄)₂SO₄, lithium hydrogen sulfate (LiHSO₄), lithium hydrogen carbonate (LiHCO₃), ammonium hydrogen carbonate (NH₄HCO₃), lithium hydroxide (LiOH) and ammonium fluoride (NH₄F).

These precursors can form the electrolyte composition by heat treating them at a temperature of about 400 to about 600° C. for a period of about 1 to about 5 hours. Using the precursors as starting materials may increase the uniformity of the electrolyte composition. Some precursors, such as LiH₂PO₄ are more easily obtained from a commercial supplier than the target ingredient LiPO₃. If in the mixing process, lithium dihydrogen phosphate LiH₂PO₄ is used instead of LiPO₃, the final composition will contain LiPO₃ upon heat treatment LiH₂PO₄. When the mixed powder is heated at about 400 to about 600° C., the LiH₂PO₄ will be converted to LiPO₃ by losing water. Li₂CO₃ can be formed from a chemical reaction between NH₄HCO₃ (or LiHCO₃) and LiOH (or Li₂O) precursors. Li₂SO₄ can be formed from a chemical reaction between (NH₄)₂SO₄ and LiOH (or Li₂O), while LiF can be formed from chemical reaction between NH₄F and LiOH (or Li₂O).

In another embodiment, the electrolyte composition is produced by spray drying a solution containing Li⁺, H₂PO₄⁻, SO₄²⁻, F⁻ and CO₃²⁻. A solution or slurry comprising the foregoing ions is first prepared. The solution or slurry may be an aqueous solution. The solution or slurry is sprayed from a spray dryer to form a mixed powder (mixture). The electrolyte composition is formed after heat-treating the mixture at a temperature of about 400 to about 600° C. for about 1 to about 5 hours. At this temperature, the powdered mixture is partially sintered but does not begin to flow. During the heating of the powdered mixture, a vacuum may be used to facilitate the rapid evaporation of moisture and other evaporative species from the electrolyte composition. The sintered solid may be further ground or milled to form the electrolyte composition. The electrolyte composition is then cold pressed to form a pellet.

The electrolyte composition displays a specific conductivity of less than 10⁻⁷ Siemens per centimeter (S/cm) when the temperature is lower than 100° C. and greater than 10⁻³ S/cm when the temperature is greater than 400° C. It can be used at temperatures of about 350 to about 600° C. in a battery and displays a high ionic conductivity and chemical stability at the temperature of operation. It is not oxidized or degraded by the cathode or anode when operating at such elevated temperatures. The electrolyte may also be used as an ingredient to manufacture the anode and/or the cathode.

In addition to the lithium salts in the electrolyte composition, other salts or oxides may be also added to the electrolyte composition to improve ionic conductivity. Other salts that may be added to the electrolyte composition are sodium salts, cesium salts, potassium salts, rubidium salts, lithium salts, or the like, or a combination comprising at least one of the foregoing salts. Examples of sodium salts, cesium salts, potassium salts, rubidium salts, lithium salts are NaPO₃, KPO₃, RbPO₃, CsPO₃, Li₃PO₄, Na₃PO₄, K₃PO₄, Rb₃PO₄, Cs₃PO₄, Na₂SO₄, K₂SO₄, Rb₂SO₄, Cs₂SO₄, Na₂CO₃, K₂CO₃, Rb₂CO₃, Cs₂CO₃, NaF, KF, RbF, CsF, Li₄P₂O₇, Na₄P₂O₇, K₄P₂O₇, Rb₄P₂O₇, Cs₄P₂O₇, LiBO₂, NaBO₂, KBO₂, RbBO₂, CsBO₂, Li₂B₄O₇, Na₂B₄O₇, K₂B₄O₇, Rb₂B₄O₇, Cs₂B₄O₇, Li₂SiO₄, Na₂SiO₄, K₂SiO₄, Rb₂SiO₄, Cs₂SiO₄, Li₂O, Na₂O, K₂O, Rb₂O, Cs₂O, LiSO₃F, NaSO₃F, KSO₃F, RbSO₃F, CsSO₃F, or the like, or a combination comprising at least one of the foregoing salts.

The electrolyte composition can be advantageously used in a battery. The battery can consisting of one or more electrochemical cells that contain the electrolyte composition.

The electrochemical cell contains an anode that comprises a metal. The metal comprises Li, LiSi alloy, LiAl alloy, LiB alloy, Ca, Mg, or their alloys. In one embodiment, the electrochemical cell contains a cathode that comprises metal oxides. The metal oxides include CuV₂O₆, Cu₂V₂O₇, Cu₃V₂O₈, Cu₅V₂O₁₀, V₂O₄, V₂O₅, LiV₃O₈, V₆O₁₃, MnO₂, LiMn₂O₄, KMnO₄, K₂MnO₄, LiMnO₃, NiO, LiNiO₂, LiCoO₂, CrO₃, CrO₂, CaCrO₄, K₂CrO₄, K₂Cr₂O₇, MoO₃, WO₃, Fe₂O₃, K₂FeO₄, CuO, LiCuO₂, PbO₂, SnO₂, or a combination comprising at least one of the foregoing metal oxides.

In another embodiment, the electrochemical cell contains a cathode that comprises fluorides. The fluorides can be metal fluorides. The fluorides include CuF₂, AgF, AgF₂, NiF₂, NiF₃, CoF₃, FeF₆, MnF₄, MnF₆, CrF₄, CrF₃, CrF₆, MoF₆, WF₆, VF₅, or a combination comprising at least one of the foregoing fluorides.

In another embodiment, the electrochemical cell contains a cathode that comprises chlorides. The chlorides can be metal chlorides. The chlorides include CuCl₂, NiCl₂, AgCl, CoCl₃, FeCl₃, MnCl₃, MnOCl₂, CrCl₃, CrO₂Cl₂, MoCl₃, MoO₂Cl₂, VCl₃, VOCl₃, or a combination comprising at least one of the foregoing chlorides.

The battery can comprise cell stacks that have bi-polar electrodes. The battery is rechargeable and can be a reserve type of battery with built in activation components.

The following examples, which are meant to be exemplary, not limiting, illustrate compositions and methods of manufacturing of some of the various embodiments of the electrolyte compositions described herein.

### EXAMPLES

### Example 1

The electrolyte composition was made by mixing vacuum oven dried LiPO₃, Li₂SO₄, Li₂CO₃, and LiF having weights of 17.2 grams (g), 10.99 g, 7.39 g, and 5.19 g respectively. LiPO₃ was produced from heating LiH₂PO₄ at 300° C. for 1 to 5 hours. The LiH₂PO₄ is commercially available from Alfa Aesar or Aldrich. The Li₂SO₄ is commercially available from Alfa Aesar or Aldrich. The Li₂CO₃ is commercially available from Alfa Aesar or Aldrich and the LiF is commercially available from Alfa Aesar or Aldrich.

After mixing the LiPO₃, Li₂SO₄, Li₂CO₃ and LiF, the resulting powder (mixture) was heated to 600° C. for 2 hours in a tube furnace. At 600° C., the mixture was partially melted and sintered but not fully liquefied. The sintered solid was crushed and milled to produce the electrolyte composition. 0.13 g of the electrolyte composition was pressed to form a pellet having a 12.7 millimeter (mm) diameter and a thickness of 0.45 mm.

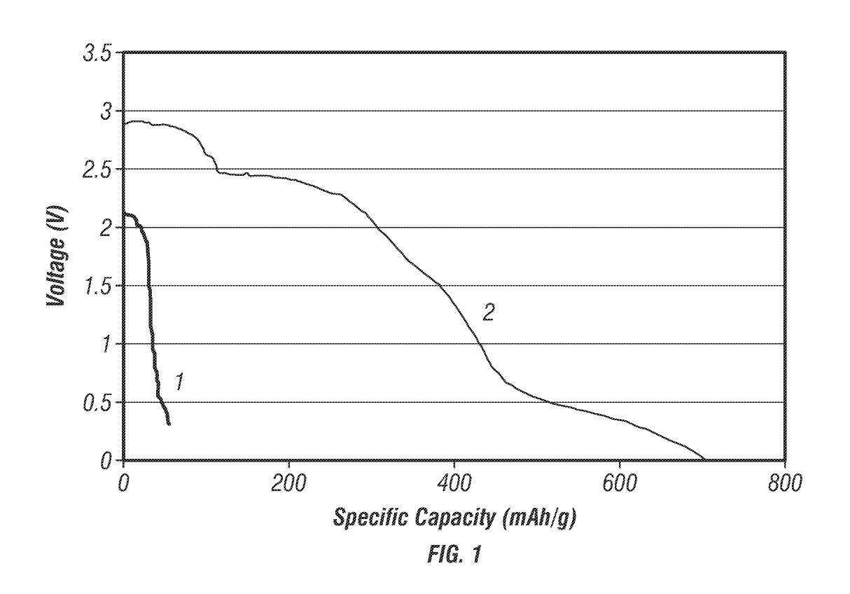

The cathode was a pellet made by cold-pressing the mixed powder of Cu₃V₂O₈ and the electrolyte composition. The mass composition of cathode was 75 wt % Cu₃V₂O₈ and 25 wt % of the electrolyte composition. The anode was a pressed LiSi (alloy) pellet. A cathode limited thermal cell was formed by sandwiching the pellet comprising the electrolyte composition between the cathode and the anode pellets. The cell was heated to 500° C. at rate of 20° C. per minute and discharged at a constant temperature of 500° C. The result may be seen in the curve 2 of the FIG. 1.

A control cell was made with the same cathode, anode, and current collector, but with a standard LiCl-KCl-MgO electrolyte/separator pellet. The discharge profile of the control cell is also shown (curve 1 of the FIG. 1) for comparison. Due to the incompatibility of the electrolyte, the cell with the LiCl-KCl-MgO electrolyte/separator only delivered 35.7 milliampere hours per gram (mAh/g) specific capacity based on a 1 Volt (V) cutoff voltage. The specific capacity was calculated based on the mass of the cathode active material. The average working voltage was only 1.89 V. The cell with the disclosed electrolyte composition (LiPO₃, Li₂SO₄, Li₂CO₃ and LiF) delivered 430 mAh/g specific capacity based on a 1V cutoff voltage, which was 394 mAh/g higher than the cell with the LiCl-KCl-MgO electrolyte/separator pellet. The average working voltage was 2.24 V, which was 0.35 V higher than the cell with the LiCl-KCl-MgO electrolyte/separator pellet.

### Example 2

A thermal cell having an electrolyte composition pellet of 12.7 mm diameter was made by the same procedure and the similar components as described in Example 1. The cathode is a plasma sprayed LiV₃O₈ cathode. The cathode was made by a plasma thermal spray of LiV₃O₈ on a stainless steel current collector. The thickness of the current collector was 120 micrometers (μm). Once again, the thermal cell was designed as cathode limited. The invented electrolyte/separator pellet was made as described in Example 1. The anode was also the same as that described in Example 1. A control cell was made with the same size, and the same cathode, anode, and current collectors, but the electrolyte/separator pellet contained LiCl-KCl-MgO.

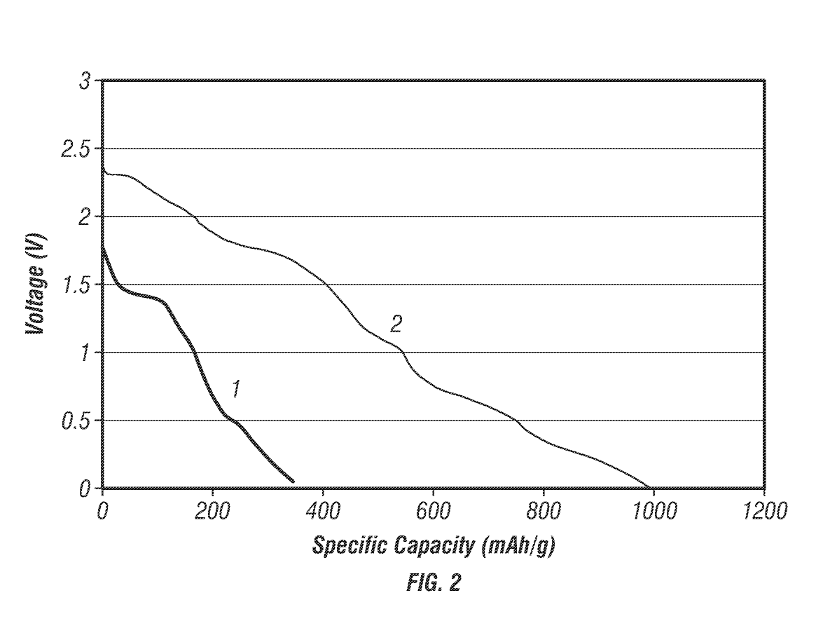

The two cell discharge profiles are illustrated in the FIG. 2. The control cell delivered 166 mAh/g based on a 1.0 V cutoff voltage (curve 1); while the cell with the disclosed electrolyte composition (LiPO₃, Li₂SO₄, Li₂CO₃ and LiF) delivered 540 mAh/g specific capacity at a voltage of 1.0 V (curve 2). The improvement was 374 mAh/g. The average working voltage of the control cell was 1.39 V (curve 1); while the average working voltage of the cell with invented electrolyte/separator was 1.76 V (curve 2). The improvement on average working voltage is 0.37 V.

### Example 3

A thermal battery comprising 11 cells was made by stacking the cells in a bipolar fashion. In the bipolar structure, one current collector has one side as an anode (negative electrode) and other side as a cathode (positive electrode). The diameter of cells for experimental batteries was 12.7 mm. The anode, electrolyte/separator, and cathode were made by cold pressing their powders respectively. The electrolyte powder was made as described in the Example 1. The anode powder was formulated by mixing the powder of LiSi alloy with 44% wt lithium and the electrolyte in a weight ratio of 9:1. The cathode powder was formulated by mixing Cu₃V₂O₈ powder with the electrolyte with weight ratio of 4:1.

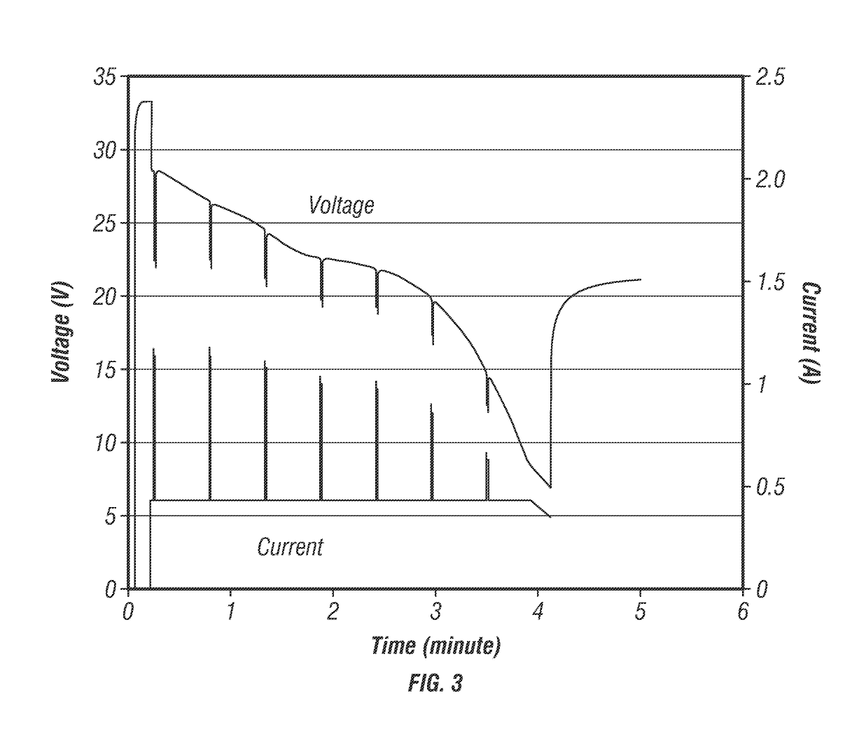

The battery was tested at a 0.432 ampere constant current loading and 1.2 ampere current 0.5 second pulse loading. The battery operated for 4 minutes without an electric short (FIG. 3). After activation, the OCV reached 33.2 V, which equivalent to 3.02 V per cell. The voltage dropped to 28.5 V upon loaded with 0.432 A current. The polarization was 10.9 ohm calculated from voltage dropping and load. At the first 1.2 A pulse, the voltage dropped to 21.9 V, giving out a 8.6 ohm polarization.

At the second pulse (0.8 minutes), the voltage dropped to 21.9 V from 26.5 V, equaling to 6.0 ohm polarization. The battery ran for about 3 minutes to a 20 V cutoff voltage. At 3.6 minutes, the loading voltage was 13.5 V when the loading current started to drop due to low voltage. The battery voltage can resume back after 20 V after the removal of the load, which exemplifies the stability of the electrolyte.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An electrolyte composition comprising:
lithium salts; where the electrolyte composition is operative at temperatures of about 350 to about 600° C. in a battery and wherein the electrolyte composition displays a specific conductivity of less than 10⁻⁷ Siemens per centimeter (S/cm) when the temperature is lower than 100° C. and greater than 10⁻³ S/cm when the temperature is greater than 400° C.; the electrolyte composition being devoid of a separator.

2. The electrolyte composition of claim 1, wherein the electrolyte composition is a quarternary composition.

3. The electrolyte composition of claim 2, wherein the quarternary composition comprises lithium polyphosphate, lithium sulfate, lithium carbonate and lithium fluoride.

4. The electrolyte composition of claim 3, wherein the lithium polyphosphate is lithium metaphosphate.

5. The electrolyte composition of claim 3, wherein the lithium polyphosphate is present in an amount of about 10 to about 100 weight percent based on the total weight of the electrolyte composition.

6. The electrolyte composition of claim 3, wherein the lithium sulfate, lithium carbonate and lithium fluoride are each present in amounts of about 5 to about 50 wt %, based on the total weight of the electrolyte composition.

7. The electrolyte composition of claim 1, further comprising additional salts, where the additional salts are sodium salts, cesium salts, potassium salts, rubidium salts, or lithium salts.

8. The electrolyte composition of claim 7, wherein the additional salts are NaPO₃, KPO₃, RbPO₃, CsPO₃, Li₃PO₄, Na₃PO₄, K₃PO₄, Rb₃PO₄, Cs₃PO₄, Na₂SO₄, K₂SO₄, Rb₂SO₄, Cs₂SO₄, Na₂CO₃, K₂CO₃, Rb₂CO₃, Cs₂CO₃, NaF, KF, RbF, CsF, Li₄P₂O₇, Na₄P₂O₇, K₄P₂O₇, Rb₄P₂O₇, Cs₄P₂O₇, LiBO₂, NaBO₂, KBO₂, RbBO₂, CsBO₂, Li₄B₄O₇, Na₂B₄O₇, K₂B₄O₇, Rb₂B₄O₇, Cs₂B₄O₇, Li₂SiO₄, Na₂SiO₄, K₂SiO₄, Rb₂SiO₄, Cs₂SiO₄, Li₂O, Na₂O, K₂O, Rb₂O, Cs₂O, LiSO₃F, NaSO₃F, KSO₃F, RbSO₃F, CsSO₃F, or a combination comprising at least one of the foregoing salts.

9. The electrolyte composition of claim 3, wherein the lithium polyphosphate is present in an amount of about 30 to about 50 wt %, the lithium sulfate is present in an amount of about 20 to about 35 wt %, the lithium carbonate is present in an amount of about 15 to about 35 wt % and the lithium fluoride is present in an amount of about 10 to about 35 wt %, based on the total weight of the electrolyte composition.

10. The electrolyte composition of claim 3, wherein the lithium polyphosphate is present in an amount of about 40 to about 45 wt %, the lithium sulfate is present in an amount of about 25 to about 30 wt %, the lithium carbonate is present in an amount of about 17 to about 20 wt % and the lithium fluoride is present in an amount of about 10 to about 35 wt %, based on the total weight of the electrolyte composition.

11. An electrochemical cell comprising the electrolyte composition of claim 1.

12. A battery comprising the electrochemical cell of claim 11.

13. The electrochemical cell of claim 11 comprising a metal anode; wherein the metal anode comprises Li, LiSi alloy, LiAl alloy, LiB alloy, Ca, Mg, or an alloy of Ca and Mg.

14. The electrochemical cell of claim 11 comprising a cathode, wherein the cathode comprises a metal oxide, the metal oxide being CuV₂O₆, Cu₂V₂O₇, Cu₃V₂O₈, Cu₅V₂O₁₀, V₂O₄, V₂O₅, LiV₃O₈, V₆O₁₃, MnO₂, LiMn₂O₄, KMnO₄, K₂MnO₄, LiMnO₃, NiO, LiNiO₂, LiCoO₂, CrO₃, CrO₂, CaCrO₄, K₂CrO₄, K₂Cr₂O₇, MoO₃, WO₃, Fe₂O₃, K₂FeO₄, CuO, LiCuO₂, PbO₂, SnO₂, or a combination comprising at least one of the foregoing metal oxides.

15. The electrochemical cell of claim 11 comprising a cathode, wherein the cathode comprises a metal fluoride, the metal fluoride being CuF₂, AgF, AgF₂, NiF₂, NiF₃, CoF₃, FeF₆, MnF₄, MnF₆, CrF₄, CrF₃, CrF₆, MoF₆, WF₆, VF₅, or a combination comprising at least one of the foregoing metal fluorides.

16. The electrochemical cell of claim 11 comprising a cathode, wherein the cathode comprises a metal chloride, the metal chloride being CuCl₂, NiCl₂, AgCl, CoCl₃, FeCl₃, MnCl₃, MnOCl₂, CrCl₃, CrO₂Cl₂, MoCl₃, MoO₂Cl₂, VCl₃, VOCl₃, or a combination comprising at least one of the foregoing metal fluorides.

17. The battery of claim 12 comprising cell stacks that comprise bi-polar electrodes.

18. The battery of claim 12, wherein the battery is a reserve type of battery with built in activation components.

19. A method comprising:
mixing together salts of lithium polyphosphate, lithium sulfate, lithium carbonate and lithium fluoride to form a mixture;
heating the mixture to a temperature of about 400 to about 600 degrees centigrade for a period of about 1 to about 5 hours; and
pressing the mixture together to form the electrolyte composition.

20. The method of claim 19, where the pressing the mixture can include injection molding the salts or compression molding the salts.

21. The method of claim 19, where the pressing the mixture can include calendaring the salts into a sheet or a film or a briquette.

22. The method of claim 19, wherein the electrolyte composition can further be tape cast to form a sheet.

23. A method comprising:
spraying a solution comprising ions of Li⁺, H₂PO₄⁻, SO₄²⁻, F and CO₃²⁻ on a substrate;
drying the solution to form a film or sheet; and
heating the film or sheet to a temperature of about 400 to about 600° C. for about 1 to about 5 hours to produce an electrolyte composition.

24. The method of claim 23, further comprising injection molding or compression molding the electrolyte composition.

25. The method of claim 23, further comprising calendaring the electrolyte solution into a sheet or a film or a briquette.
